(19) United States
(12) Patent Application Publication
(10) Pub. No.: US 2025/0073831 A1
(43) Pub. Date: Mar. 6, 2025

(54) APPARATUS FOR BRAKING A PROCESSING ELEMENT

(71) Applicant: Weber Schraubautomaten GmbH, Wolfratshausen (DE)

(72) Inventors: Erwin PFAFFENRATH, Königsdorf (DE); Sebastian BÖCK, Holzhausen (DE); Robert STÜTZER, München (DE)

(21) Appl. No.: 18/722,366

(22) PCT Filed: Dec. 16, 2022
(86) PCT No.: PCT/EP2022/086320

§ 371 Date: Jun. 20, 2024

(30) Foreign Application Priority Data
Dec. 21, 2021 (DE) 10 2021 134 091.8

(51) Int. Cl. B23P 19/00; B21J 15/32

(52) U.S. Cl. CPC B23P 19/005; B21J 15/32; B23P 19/006

(57) ABSTRACT

The application relates to a braking unit for braking a processing element, said braking unit comprising a guide channel for the processing element, wherein the guide channel has a guide channel inlet and a guide channel outlet, wherein the guide channel has at least one curved section to apply a centrifugal force to the processing element to be braked that moves along the guide channel, said centrifugal force pressing the processing element against an outer curvature region of an inner peripheral surface of the curved section, and wherein the at least one curved section is configured to brake the processing element by friction between the inner peripheral surface of the guide channel and the processing element such that the processing element loses at least 50% of its kinetic energy between the guide channel inlet and the guide channel outlet. The application furthermore relates to a method for braking a processing element comprising the steps: inserting the processing element into a curved section of a guide channel at an input speed, generating a centrifugal force on the processing element, generating a centrifugal force-induced friction between the processing element and an inner peripheral surface of the curved section of the guide channel, and braking the processing element by means of the centrifugal force-induced friction to an output speed that is at most 75% of the input speed.

The present invention relates to a braking unit for braking a processing element, in particular a fastener, such as a screw, a nail or a rivet.

Such an apparatus is generally known and is, for example, used in a screw system comprising an automatic screw feed to stop, for example, a screw fed by means of compressed air before it is brought into engagement with the screw tool.

In simple apparatus, the braking of the fed screw takes place by means of a rigid metal slider that is pushed into a guide channel to completely block it. It is problematic here that the tip of the screw can be damaged when impacting the metal slider. Furthermore, particles or chips can release from the screw or the metal slider when the screw impacts the metal slider and are subsequently transported along to the screwing point, which is in particular unwanted when increased demands are made on the cleanliness of the working conditions.

Another known apparatus therefore provides a brush comprising a large number of elastically deformable bristles as a braking element. The screw can hereby be gently braked.

However, this variant has the disadvantage that the screws to be braked place a heavy load on the bristles at high feed speeds and the brake thereby has a relatively short service life.

It is an object of the present invention to overcome the previously described disadvantages of the prior art and to provide a braking unit that gently brakes processing elements, such as screws, even at high feed speeds and has a high durability in this respect.

The object is satisfied by a braking unit having the features of claim 1.

The braking unit serves to brake a processing element, in particular a fastener such as a screw, a rivet element or a nail. The braking unit forms a guide channel for the processing element. The guide channel has a guide channel inlet and a guide channel outlet. To brake the processing element, the guide channel has at least one curved section. The curved section serves to apply a centrifugal force to the processing element to be braked that moves along the guide channel. The centrifugal force causes the processing element to be pressed against an outer curvature region of an inner peripheral surface of the curved section. The at least one curved section is configured, for example due to its type of curvature, its condition at the inner peripheral surface, its length in the conveying direction and/or other properties, to brake the processing element by friction between the inner peripheral surface of the guide channel and the processing element such that the processing element loses at least 50% of its kinetic energy between the guide channel inlet and the guide channel outlet.

The invention is based on the idea of providing a braking unit that utilizes a centrifugal force-induced friction at an inner peripheral surface of a curved guide channel section to significantly brake a processing element. The curved section of the guide channel thus serves as a brake. Tests have shown that braking units according to the invention are able to reliably brake screws even at high feed speeds without damaging the screw tip. In this respect, it has also been shown that the braking unit can be configured as low-wear, whereby typical durability requirements for such a braking unit could be satisfactorily met.

Advantageous embodiments of the invention can be seen from the dependent claims, from the description and from the drawings.

According to one embodiment, the at least one curved section is configured to brake the processing element by friction between the inner peripheral surface of the guide channel and the processing element such that the processing element loses at least 70% of its kinetic energy between the guide channel inlet and the guide channel outlet. Preferably, even at least 90% of the kinetic energy of the processing element is dissipated, i.e. converted into thermal energy by friction, between the guide channel inlet and the guide channel outlet.

According to one embodiment, the curved section has an overall curvature of more than 180°, in particular more than 270°. The curved section can be continuous and/or have a constant radius. However, the curved section can also comprise a plurality of curved part sections that are, for example, separated from one another by a straight or otherwise curved section. The curved section can comprise a first curved part section that is curved in a first direction and at least a second curved part section that is curved in a second direction, i.e. different from the first direction.

According to one embodiment, the curved section comprises a helical guide channel section. The helical guide channel section can also be referred to as spiral. The curved section can in particular be designed in the form of a looping of a roller coaster so that an orientation of a longitudinal axis of the processing element changes continuously as a result of a movement through the curved section. The helical guide channel section preferably has an overall curvature of approximately 360°.

According to an advantageous embodiment, the curved section first comprises a first S curve-shaped curved section, followed by a helical curved section and then a second S curve-shaped curved section. Central axes of the guide channel inlet and the guide channel outlet can be aligned in parallel with one another. In particular, the guide channel inlet and the guide channel outlet can be arranged in alignment with one another.

According to one embodiment, the curved section, i.e. the braking element defining the curved section or the braking elements defining the curved section, is dimensionally stable. This means that a component or components that define the curved section do not deform elastically or plastically, or only very slightly, under a load required for typical use. In other words, the at least one component that defines the curved section is rigid.

The curved section can be defined by a single component. According to an embodiment that is easy to assemble, the curved section is defined by a component manufactured in one piece. Alternatively thereto, the curved section can, for example, be manufactured by two components that are subsequently joined together, for example screwed or welded.

The component defining the curved section, i.e. the braking element, can be manufactured by means of 3D printing. This makes it particularly easy in a production aspect to manufacture the component defining the curved section in one piece. To ensure a long service life of the braking unit, it is advantageous if the component defining the curved section is made of metal, e.g. 3D printed. The material from which the component is made preferably has a higher strength than the processing elements to be braked.

In general, it is advantageous if a radius or all radii of the curved section is or are adapted to a length of the respective processing element to be braked. The 3D printing process makes it possible in a cost-effective manner to manufacture braking elements for customers that are individually adapted to the processing elements to be braked.

A radius of the curved section, i.e. a radius of curvature, is preferably in a range between 1.5 and 6 times the length of the processing element to be braked. The radius of curvature should generally be large enough that the processing element can pass through the curved section of the guide channel without tilting. On the other hand, the radius of curvature should be designed as small as possible so that the processing element experiences such a high centrifugal force and thus friction that the processing element is sufficiently braked. Each radius of the curved section is preferably in a range between 1.5 and 6 times the length of the processing element to be braked.

According to one embodiment, the radius of the curved section is smaller than 0.5 m. For commonly processed screws, for example FDS screws, it is advantageous if the radius of the curved section is smaller than 0.3 m. If the radius of the curved section is not constant, the largest radius of the curved section can be smaller than 0.5 m, in particular smaller than 0.3 m. Alternatively or additionally, an average radius of the curved section can be smaller than 0.5 m, in particular smaller than 0.3 m. Again, alternatively or additionally, the smallest radius of the curved section can be smaller than 0.5 m, in particular smaller than 0.3 m. The radius of the curved section is preferably substantially constant and is smaller than 0.5 m, in particular smaller than 0.3 m.

To further improve the braking effect of the curved section, a brake-reinforcing structure can be provided at the inner peripheral surface of the curved section. Tests have shown that a particularly good braking performance is achieved when the brake-reinforcing structure is configured to set the processing element to be braked into a tumbling movement.

According to one embodiment, the brake-reinforcing structure can be formed as a helical elevated portion on the inner peripheral surface of the curved section. In other words, an elevated portion can be formed on the inner peripheral surface of the curved section and extends spirally along the inner peripheral surface of the curved section. This brake-reinforcing structure can come into contact with the head of a fastener and can cause the fastener to make a tumbling movement. The fastener can hereby be braked particularly efficiently.

In order not to damage a tip of the processing element to be braked, e.g. a screw to be braked, a recess for receiving the tip of the processing element to be braked can extend in the outer curvature region of the inner peripheral surface of the guide channel. The recess should in this respect be designed such that the tip dips into the recess while the processing element passes through the curved section so that the tip does not come into contact with the remaining inner peripheral surface of the guide channel. The recess is preferably configured to guide the tip and to prevent the tip from coming into contact with the inner peripheral surface of the guide channel and being damaged as a result. The recess in the outer curvature region preferably extends along the conveying direction over an angle of at least 30°. Advantageously, the recess merges smoothly into the inner peripheral surface at the end of the recess.

To completely brake the processing element, which has already been partly or almost completely braked by the curved section, and to hold it in the guide channel, the braking unit can comprise a braking and holding element for completely braking and holding, in particular in a form-fitting manner, the processing element to be braked. The braking and holding element is preferably arranged at the guide channel outlet, i.e. after the curved section in the conveying direction.

According to one embodiment, the braking and holding element is adjustable, in particular pneumatically adjustable, between a release position and a holding position. The processing element to be braked can hereby be selectively held in the guide channel or released for further processing. The braking and holding element preferably only partly projects into the guide channel in the holding position. It is advantageous here if the braking and holding element is configured to come into contact solely with a head of the processing element to be held in order not to damage a tip of the processing element.

To attenuate a transport air flow for the processing elements in the region of the guide channel inlet and thus to increase the braking power, at least one air outlet opening can be provided at the guide channel inlet. A plurality of air outlet openings are preferably provided. They can be arranged distributed in the peripheral direction of the guide channel inlet.

The invention furthermore relates to a system comprising a storage container for processing elements, a feed hose, in particular having a round inner cross-section, for the processing elements from the storage container to a processing device, and a braking unit having at least one of the preceding or following features that, in an end region of the feed hose, is arranged in front of the processing device in the conveying direction.

Preferably, the entire system, i.e. the storage container, the feed hose and the processing device, is configured for processing fasteners that in particular have a head and a shaft, for example screws. It is advantageous if the entire system is adapted to convey the processing elements such that a main direction of extent of the processing elements is arranged in the conveying direction. If the processing elements have a head and a shaft, the processing elements can either be conveyed with the head first or with the head last.

The invention furthermore relates to a method for braking a processing element, in particular using a braking unit according to at least one of the preceding or following features,
comprising the steps:
inserting the processing element into a curved section of a guide channel at an input speed,
generating a centrifugal force on the processing element,
generating a centrifugal force-induced friction between the processing element and an inner peripheral surface of the curved section of the guide channel, and
braking the processing element by means of the centrifugal force-induced friction to an output speed that is at most 75%, in particular at most 50%, of the input speed.

The processing element is preferably braked by means of the centrifugal force-induced friction to an output speed that is at most 30% of the input speed, in particular at most 10% of the input speed.

According to one embodiment, the processing element is set into a tumbling movement in the curved section of the guide channel, in particular by a contact with a brake-reinforcing structure. The braking effect is hereby enhanced.

The method and the braking unit are particularly suitable for processing elements having a shaft and a head that is widened with respect to the shaft. The method is particularly suitable for processing elements having a weight of more than 3 grams, in particular for processing elements between 4 and 7 grams.

If the processing element has a head, it is advantageous if the centrifugal force-induced friction between the processing element and the inner peripheral surface is predominantly generated between the head of the processing element and the inner peripheral surface.

The invention will be described with reference to purely exemplary embodiments and to the enclosed drawings in the following. There are shown:

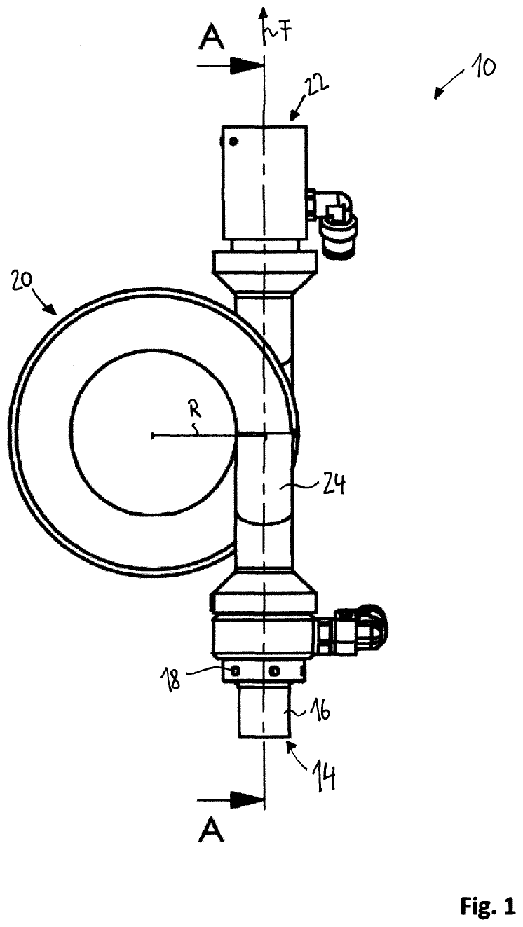

FIG. 1 a side view of a braking unit according to the invention;

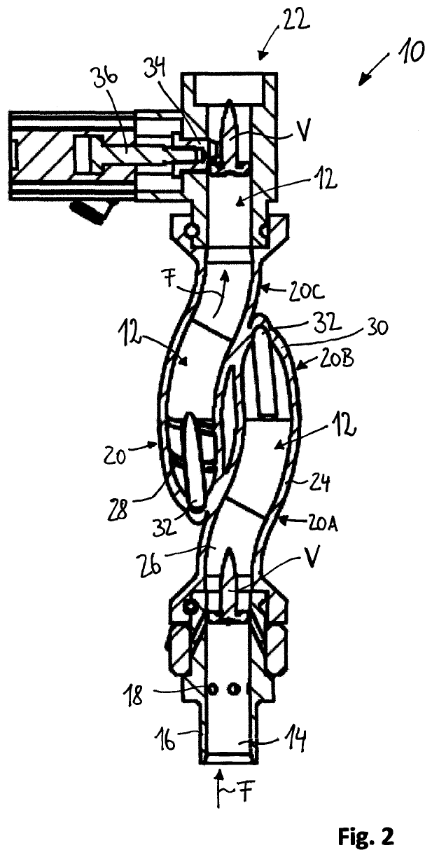

FIG. 2 a sectional representation along the sectional plane A-A of FIG. 1;

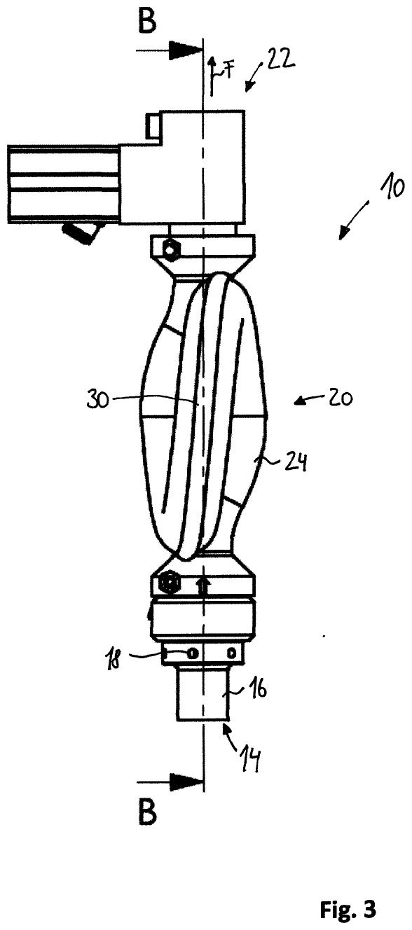

FIG. 3 a plan view of the braking unit of FIG. 1;

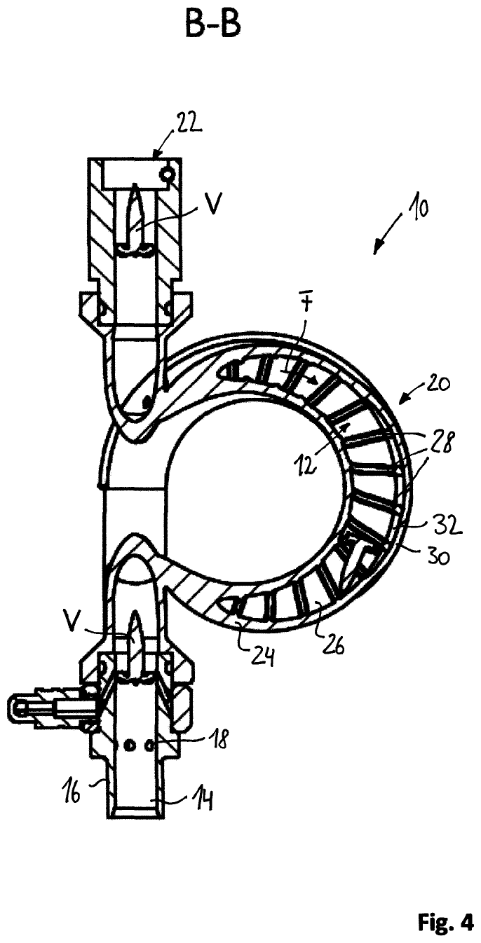

FIG. 4 a sectional representation along the sectional plane B-B of FIG. 3;

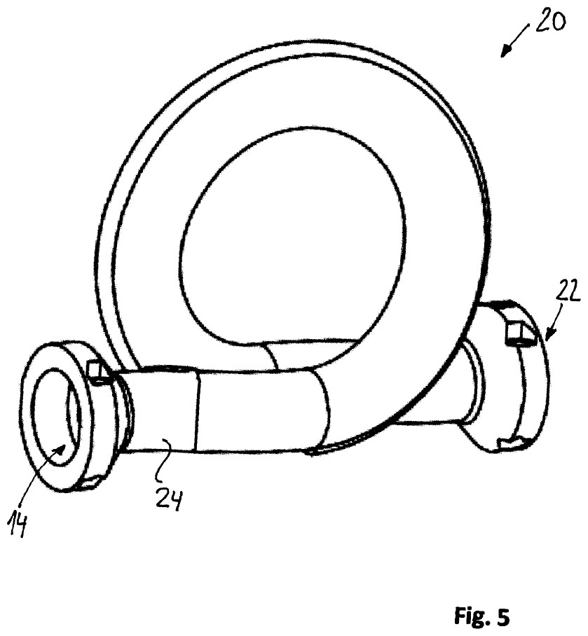

FIG. 5 a perspective view of a curved section of the braking unit of FIG. 1;

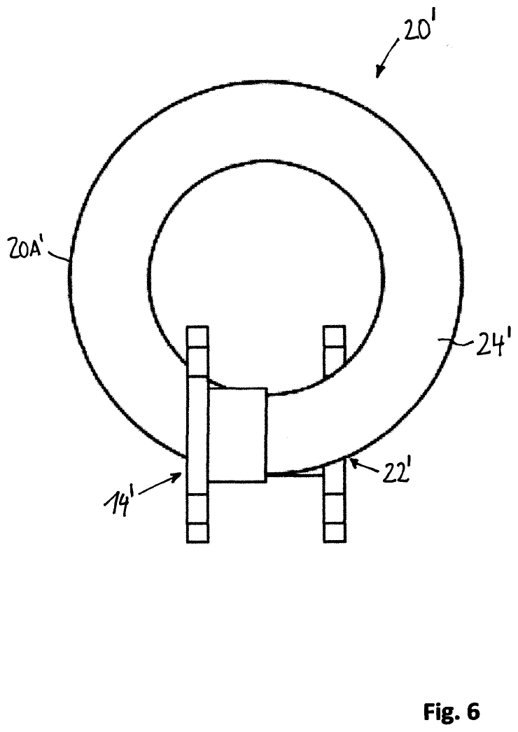

FIG. 6 a side view of a curved section according to a second embodiment;

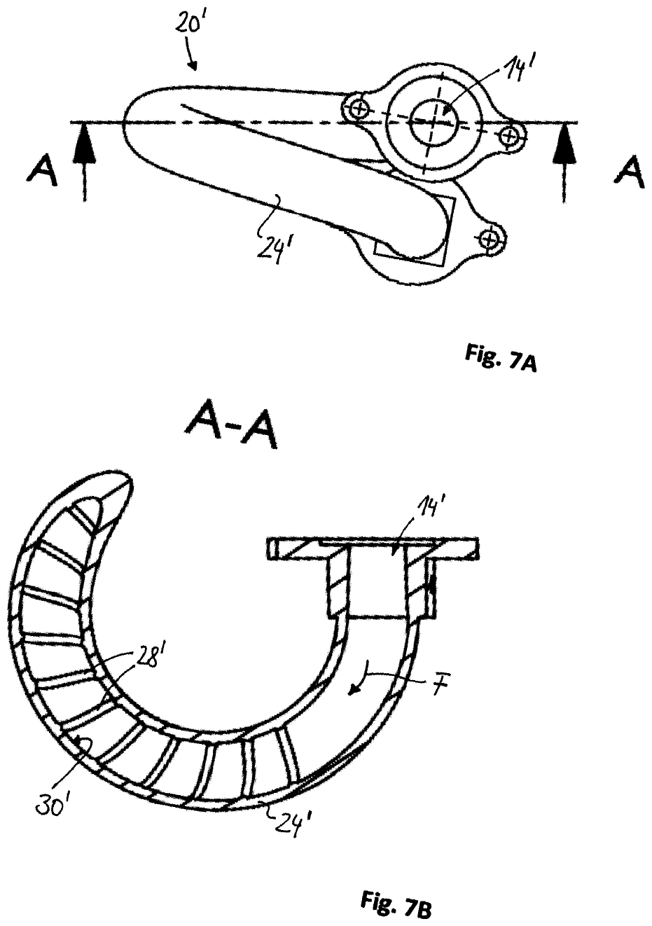

FIG. 7A a front view of the curved section of FIG. 6;

FIG. 7B a sectional representation along the sectional plane A-A of FIG. 7A;

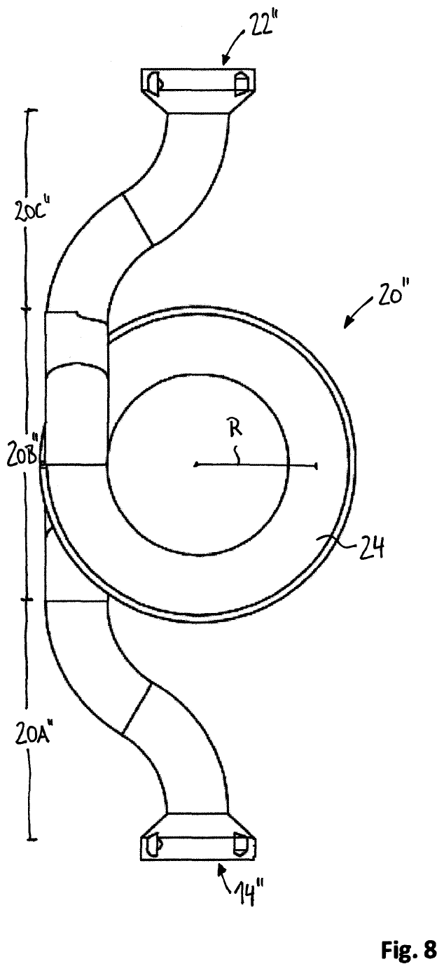

FIG. 8 a side view of a curved section according to a third embodiment;

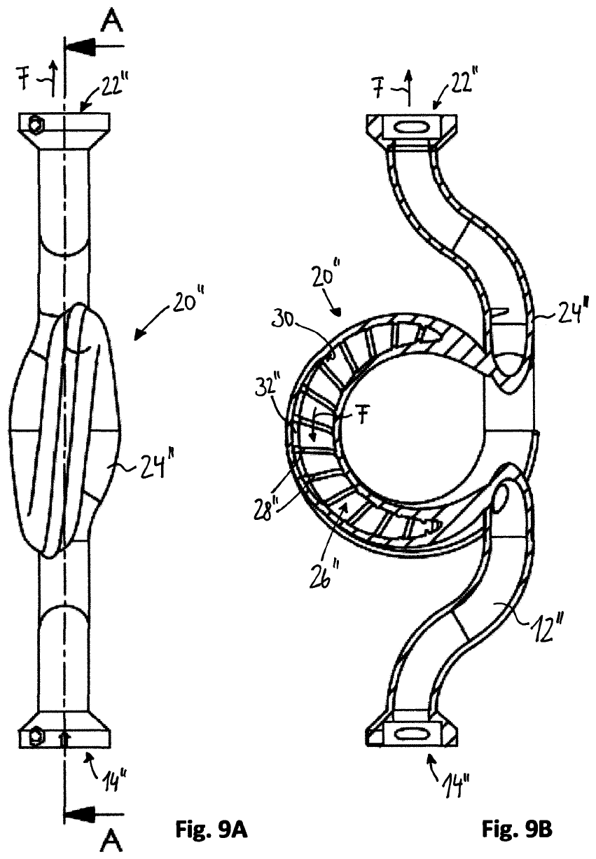

FIG. 9A a plan view of the curved section of FIG. 8; and

FIG. 9B a sectional representation along the sectional plane A-A of FIG. 9A.

FIGS. 1 to 4 show a braking unit 10 according to a first embodiment. The braking unit 10 serves to brake processing elements V fed by means of air pressure, in particular fasteners such as screws, before they are delivered to a processing device, not shown, for example a screwing apparatus. The braking unit 10 defines a guide channel 12 (see FIG. 2) for the processing elements V. The processing element V to be braked is conveyed through the guide channel 12 and braked in the process by applying friction to the processing element V along the guide channel 12.

A guide channel inlet 14, through which the processing elements V enter the braking unit 10, is provided at the braking unit 10. The guide channel inlet 14 has an interface 16 to connect the guide channel inlet 14 to a feed hose, not shown.

The feed hose as well as the guide channel 12 are configured to transport processing elements V such that a main direction of extent of the processing elements V is oriented in the conveying direction F. For this purpose, it is advantageous, specifically for substantially rotationally symmetrical processing elements V, such as screws, if the feed hose and the guide channel 12 have an at least substantially round inner cross-section. To partly release the compressed air required for transporting the processing elements V through the feed hose at the guide channel inlet 14, radially extending air outlet openings 18 are provided at the guide channel inlet 14.

A curved section 20 extends adjoining the guide channel inlet 14. The curved section 20 serves to brake the processing element V. As can be seen in FIG. 2, the curved section 20 can have a first, S curve-shaped section 20A, then a second, helical section 20B, and finally a third, S curve-shaped section 20C. It is hereby possible to design the curved section 20 as particularly compact and to ensure that the guide channel inlet 14 is arranged substantially in alignment with a guide channel outlet 22 following the S curve-shaped section 20C.

The curved section 20 of the guide channel 12 is defined by a single component 24. This component 24 can also be called a braking element 24 due to its function of braking the processing element V. The braking element 24 substantially completely surrounds the guide channel 12 at the peripheral side so that the processing elements V are securely guided along the guide channel 12. In other words, the braking element 24 has an inner peripheral surface 26 that forms the curved section 20 of the guide channel 12. The braking element 24 is manufactured using a 3D printing process. Metal alloys that can be processed in a 3D printing process and are wear-resistant are suitable as materials for manufacturing the braking element 24. The strength of the braking element 24 is greater than the strength of the corresponding processing elements V.

To further increase the braking effect of the braking element 24, a brake-reinforcing structure 28 is provided at the inner peripheral surface 26 of at least a part region of the curved section 20. The brake-reinforcing structure 28, which can in particular be seen in FIG. 4, is designed as a helical or spiral elevated portion 28 along the inner peripheral surface 26. The elevated portion 28 has a substantially constant cross-section. The cross-section of elevated portion 28 resembles the shape of a flat sine wave. In other words, the elevated portion 28 is shaped such that a height of the elevated portion 28, viewed in the conveying direction F, increases steadily up to its maximum and then drops steadily again. Furthermore, the elevated portion 28 is rounded in the region of its maximum so that the elevated portion 28 does not form any edges. The elevated portion 28 merges smoothly into the further inner peripheral surface 26.

In an outer curvature region 30 of the inner peripheral surface 26 of the guide channel 12, a recess 32 (see FIG. 4) extending in the transport direction or conveying direction F is furthermore configured to receive a tip of the processing element V to be braked. This recess 32 makes it possible for the tip of the processing element V to be braked to dip into the recess 32 and thereby come into contact with flanks of the recess 32 at the peripheral side, instead of coming into contact with the outer curvature region 30 of the inner peripheral surface 26 with the end-face tip. On the one hand, this has the advantage that the tip of the processing element is spared. On the other hand, the recess 32 also has the effect that the service life of the braking element 24 can be extended.

As can be seen in FIG. 2, a braking and holding element 34 is provided at the guide channel outlet 22. The braking and holding element 34 is linearly guided and is linearly moveable between a holding position (see FIG. 2) and a release position by a pneumatic piston 36. In the holding position, the braking and holding element 34 partly projects into the guide channel 12 to hold the processing element V at its head and thus prevent it from moving further in the conveying direction F.

Preferably, the braking and holding element 34 is likewise configured to prevent the processing element V from moving against the conveying direction F.

FIG. 5 shows the actual braking element 24 separately, i.e. without the modules defining the guide channel inlet 14 and the guide channel outlet 22. It can be seen from FIGS. 1, 4 and 5 that a radius R of the helical curved section 20 is in a range between 2 and 10 times an inner diameter, in particular between 3 and 8 times the inner diameter, of the guide channel 12. Thus, the radius R is relatively small to apply a relatively large centrifugal force to the processing element V.

FIGS. 6, 7A and 7B show an alternative, more compact embodiment of a curved section 20′ of the braking unit 10. Compared to the embodiment shown in FIGS. 1 to 5, this more compact embodiment has only one helical section 20A′, but no S curve-shaped sections. The guide channel inlet 14′ of the curved section 20′ is thereby arranged radially offset from the guide channel outlet 22′ of the curved section 20′, unlike in the embodiment example of FIG. 1. This curved section 20′ is also defined by a single component 24′. This component 24′ is made of metal and is manufactured in the 3D printing process. As can be seen in FIG. 7B, the component 24′ also has a brake-reinforcing structure 28 in the form of a spiral rib at its inner peripheral surface 26.

FIGS. 8, 9A and 9B show a third embodiment of a curved section 20″. Similar to the curved section 20 of FIG. 1, the curved section 20″ has a first, S curve-shaped section 20A″, then a second, helical section 20B″, and finally a third, S curve-shaped section 20C″. Furthermore, the first and third embodiments have in common that the guide channel inlet 14″ and the guide channel outlet 22″ are arranged in alignment with one another, as can be seen in FIGS. 8 and 9A. While a connecting line between the guide channel inlet 14 and the guide channel outlet 22 forms a tangent of the helical curved section 20B in the first embodiment, a connecting line between the guide channel inlet 14″ and the guide channel outlet 22″ divides the helical curved section 20B″ approximately in the middle.

### Reference Numeral List

10 braking unit
12 guide channel
14 guide channel inlet
16 interface
18 air outlet opening
20 curved section
22 guide channel outlet
24 component
26 inner peripheral surface
28 brake-reinforcing structure
30 outer curvature region
32 recess
34 braking and holding element
36 pneumatic piston
V processing element
F conveying direction
R radius

1-22. (canceled)

23. A braking unit for braking a processing element,
said braking unit comprising a guide channel for the processing element, wherein the guide channel has a guide channel inlet and a guide channel outlet, and
wherein the guide channel has at least one curved section to apply a centrifugal force to the processing element to be braked that moves along the guide channel, said centrifugal force pressing the processing element against an outer curvature region of an inner peripheral surface of the curved section,
and wherein the at least one curved section is configured to brake the processing element by friction between the inner peripheral surface of the guide channel and the processing element such that the processing element loses at least 50% of its kinetic energy between the guide channel inlet and the guide channel outlet.

24. The braking unit according to claim 23,
wherein the at least one curved section is configured to brake the processing element by friction between the inner peripheral surface of the guide channel and the processing element such that the processing element loses at least 70% of its kinetic energy between the guide channel inlet and the guide channel outlet.

25. The braking unit according to claim 23,
wherein the at least one curved section has an overall curvature of more than 180°.

26. The braking unit according to claim 23,
wherein the curved section comprises a helical guide channel section.

27. The braking unit according to claim 23,
wherein the curved section is dimensionally stable.

28. The braking unit according to claim 23,
wherein the curved section is defined by a single component.

29. The braking unit according to claim 23,
wherein a component defining the curved section is manufactured by means of 3D printing.

30. The braking unit according to claim 23,
wherein a radius of the curved section is in a range between 1.5 and 6 times the length of the processing element to be braked.

31. The braking unit according to claim 23,
wherein a radius of the curved section is smaller than 0.5 m.

32. The braking unit according to claim 23,
wherein a brake-reinforcing structure is provided at the inner peripheral surface of the curved section.

33. The braking unit according to claim 32,
wherein the brake-reinforcing structure is configured to set the processing element to be braked into a tumbling movement.

34. The braking unit according to claim 32,
wherein the brake-reinforcing structure is formed as a helical elevated portion on the inner peripheral surface of the curved section.

35. The braking unit according to claim 23,
wherein a recess for receiving a tip of the processing element to be braked extends in the outer curvature region of the inner peripheral surface of the guide channel.

36. The braking unit according to claim 23,
wherein the braking unit comprises a braking and holding element for completely braking and holding the processing element to be braked.

37. The braking unit according to claim 36,
wherein the braking and holding element is adjustable between a release position and a holding position to selectively hold the processing element to be braked in the guide channel or to release it for further processing.

38. The braking unit according to claim 23,
wherein at least one air outlet opening is provided in the region of the guide channel inlet to release compressed air required for conveying the processing element.

39. A system comprising
a storage container for processing elements,
a feed hose for the processing elements from the storage container to a processing device,
and a braking unit that, in an end region of the feed hose, is arranged in front of the processing device in the conveying direction, said braking unit comprising a guide channel for the processing element, wherein the guide channel has a guide channel inlet and a guide channel outlet, and
wherein the guide channel has at least one curved section to apply a centrifugal force to the processing element to be braked that moves along the guide channel, said centrifugal force pressing the processing element against an outer curvature region of an inner peripheral surface of the curved section,
and wherein the at least one curved section is configured to brake the processing element by friction between the inner peripheral surface of the guide channel and the processing element such that the processing element loses at least 50% of its kinetic energy between the guide channel inlet and the guide channel outlet.

40. The system according to claim 39,
wherein the processing device is configured for processing fasteners.

41. A method for braking a processing element,
comprising the steps:
inserting the processing element into a curved section of a guide channel at an input speed,
generating a centrifugal force on the processing element,
generating a centrifugal force-induced friction between the processing element and an inner peripheral surface of the curved section of the guide channel, and
braking the processing element by means of the centrifugal force-induced friction to an output speed that is at most 75% of the input speed.

42. The method according to claim 41,
wherein the processing element is set into a tumbling movement in the curved section of the guide channel.

43. The method according to claim 41,
wherein the processing element has a head and a shaft.

44. The method according to claim 43,
wherein the centrifugal force-induced friction between the processing element and the inner peripheral surface is predominantly generated between the head of the processing element and the inner peripheral surface.
